(19) United States
(12) Patent Application Publication
(10) Pub. No.: US 2007/0298743 A1
(43) Pub. Date: Dec. 27, 2007

(54) Data communication device for wireless microphone

(75) Inventor: Ming-Cheng Chung, Taichung (TW)

Correspondence Address: BACON & THOMAS, PLLC, 625 SLATERS LANE, FOURTH FLOOR, ALEXANDRIA, VA, 22314, US

(73) Assignee: JTS PROFESSIONAL CO., LTD., Taichung (TW)

(21) Appl. No.: 11/472,363

(22) Filed: Jun. 22, 2006

(51) Int. Cl. H04B 1/18

(52) U.S. Cl. 455/187.1

(57) ABSTRACT

An RFID based apparatus mounted in each of a wireless microphone and a device includes a transceiver unit including a control panel a controller having a memory for storing data including a set frequency and set parameters, an encoder, a modulator, and an antenna; and a transponder unit including a demodulator and a decoder. In one embodiment, the antenna of the device is adapted to receive an incoming RFID signal from the wireless microphone, the demodulator of the device is adapted to recover the RFID signal, the decoder of the device is adapted to decode the data, and the controller of the device is adapted to read and write the data to the memory prior to transmitting a response to the transceiver unit of the wireless microphone.

### BACKGROUND OF THE INVENTION

1. Field of Invention

The present invention relates to wireless microphones and more particularly to an RFID (radio-frequency identification) based wireless microphone incorporating a transceiver unit and a transponder unit capable of communicating data with a corresponding RFID based device incorporating same by half duplex technique.

2. Related Art

A variety of microphones are commercially available. Conventionally, a microphone is wired. Recently, a type of wireless microphone is developed. More recently, wireless microphones having a receiver and a transmitter both capable of selecting one of a plurality of available frequencies for operation are developed. However, problems such as interference, inconvenient operation, etc. exist in wireless communication. Thus, a need for improvement exists.

### SUMMARY OF THE INVENTION

It is therefore an object of the present invention to provide an RFID based wireless microphone incorporating a transceiver unit and a transponder unit capable of communicating data with a corresponding RFID based device incorporating same by half duplex technique.

To achieve the above and other objects, the present invention provides an apparatus mounted in each of a wireless microphone and a device for communicating data therebetween in half duplex, comprising a transceiver unit including a control panel including a plurality of keys, a controller electrically connected to the keys and having a memory adapted to store data including a set frequency and set parameters, an encoder adapted to encode data, a modulator adapted to vary the set frequency of the data in accordance with an RFID signal, and an antenna adapted to transmit the modulated RFID signal contained the data over a carrier wave; and a transponder unit including a demodulator and a decoder; wherein either the antenna of the device is adapted to receive the incoming RFID signal from the wireless microphone, the demodulator of the device is adapted to recover the received RFID signal, the decoder of the device is adapted to decode the recovered, encoded data, and the controller of the device is adapted to read and write the data to the memory prior to transmitting a response to the transceiver unit of the wireless microphone; or the antenna of the wireless microphone is adapted to receive the incoming RFID signal from the device, the demodulator of the wireless microphone is adapted to recover the received RFID signal, the decoder of the wireless microphone is adapted to decode the recovered, encoded data, and the controller of the wireless microphone is adapted to read and write the data to the memory prior to transmitting a response to the transceiver unit of the device.

The above and other objects, features and advantages of the present invention will become apparent from the following detailed description taken with the accompanying drawings.

### BRIEF DESCRIPTION OF THE DRAWINGS

FIG. 1 is a block diagram of a preferred embodiment of the invention.

### DETAILED DESCRIPTION OF THE INVENTION

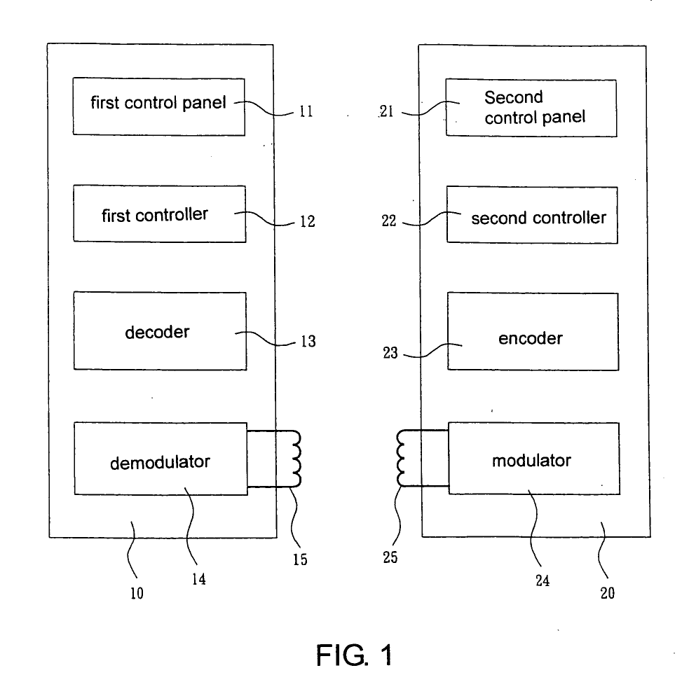

Referring to FIG. 1, a preferred embodiment of the invention is shown. The preferred embodiment comprises a transceiver unit and a transponder unit both incorporated in each of a wireless microphone and a corresponding device. For ease of discussion, one transceiver unit 20 is mounted in a wireless microphone and one transponder unit 10 is mounted in a corresponding device. Both components are discussed in detailed below.

The transceiver unit 20 comprises a second control panel 21 including a plurality of keys (not shown), a second controller 22 electrically connected to the keys and having a memory adapted to allow a user to select one of a plurality of frequencies and set same select one of a plurality of channels and set same, and select a signal transmission power and set same by pressing the key(s), an encoder 23 adapted to encode data (i.e., the settings), a modulator 24 adapted to vary the set frequency of the settings in accordance with an RFID signal, and a second antenna 25 adapted to transmit the modulated RFID signal contained the data over a carrier wave.

The transponder unit 10 comprises a first antenna 15 adapted to receive the incoming RFID signal transmitted from the second antenna 25, a demodulator 14 adapted to recover the received RFID signal, a decoder 13 adapted to decode the recovered, encoded data contained in the RFID signal, a first control panel 11 including a plurality of keys (not shown), and a first controller 12 electrically connected to the keys and adapted to read and write the data to its memory prior to transmitting a response to the transceiver unit 20 via the first antenna 15 (i.e., finish communication).

Note that the above data communication can also be done by half duplex. That is, data can be sent either from the transceiver unit in the wireless microphone to the transponder unit in the corresponding device as described above or from the transceiver unit in the corresponding device to the transponder unit in the wireless microphone in other embodiments. In either case, the data communication as contemplated by the invention is correct and reliable.

While the invention herein disclosed has been described by means of specific embodiments, numerous modifications and variations could be made thereto by those skilled in the art without departing from the scope and spirit of the invention set forth in the claims.

What is claimed is:

1. An apparatus mounted in each of a wireless microphone and a device for communicating data therebetween in half duplex, comprising:
a transceiver unit including a control panel including a plurality of keys, a controller electrically connected to the keys and having a memory adapted to store data including a set frequency and set parameters, an encoder adapted to encode data, a modulator adapted to vary the set frequency of the data in accordance with an RFID signal, and an antenna adapted to transmit the modulated RFID signal contained the data over a carrier wave; and
a transponder unit including a demodulator and a decoder; wherein:
either the antenna of the device is adapted to receive the incoming RFID signal from the wireless microphone, the demodulator of the device is adapted to recover the received RFID signal, the decoder of the device is adapted to decode the recovered, encoded data, and the controller of the device is adapted to read and write the data to the memory prior to transmitting a response to the transceiver unit of the wireless microphone; or
the antenna of the wireless microphone is adapted to receive the incoming RFID signal from the device, the demodulator of the wireless microphone is adapted to recover the received RFID signal, the decoder of the wireless microphone is adapted to decode the recovered, encoded data, and the controller of the wireless microphone is adapted to read and write the data to the memory prior to transmitting a response to the transceiver unit of the device.
